(19) United States
(12) Patent Application Publication
(10) Pub. No.: US 2023/0075558 A1
(43) Pub. Date: Mar. 9, 2023

(54) Nutritional Composition and Process for Preparing It

(71) Applicant: CARGILL, INCORPORATED, Wayzata, MN (US)

(72) Inventors: Nils BILLECKE, Sint-Genesius-Rode (BE); Eliane GOOSSENS, NIEL (BE); Gustav Maximilian WASCHATKO, Etterbeek (BE)

(73) Assignee: CARGILL, INCORPORATED, Wayzata, MN (US)

(21) Appl. No.: 17/785,151

(22) PCT Filed: Nov. 9, 2020
(86) PCT No.: PCT/US2020/059605

§ 371 Date: Jun. 14, 2022

(30) Foreign Application Priority Data
Dec. 16, 2019 (EP) 19216529.8
Jan. 15, 2020 (EP) 20151968.3
May 12, 2020 (EP) 20174111.3

(51) Int. Cl. A23L 33/115; A23L 33/00; A23L 33/17; A23L 33/125

(52) U.S. Cl. CPC A23L 33/115; A23L 33/40; A23L 33/17; A23L 33/125; A23V 2002/00

(57) ABSTRACT

The present invention relates to a nutritional composition comprising isolated and/or enlarged oleosomes and at least one nutritional ingredient other than isolated and/or enlarged oleosomes, wherein the isolated and/or enlarged oleosomes have an average globule diameter in a range of from 2.0 to 12.0 micron. The invention further relates to a process for preparing the nutritional composition and the process is comprising the blending of the isolated and/or enlarged oleosomes with the at least one other nutritional ingredient other than isolated and/or enlarged oleosomes, and characterized in that the isolated and/or enlarged oleosomes are in powder or liquid form.

### FIELD OF THE INVENTION

The invention relates to a nutritional composition comprising isolated and/or enlarged oleosomes and at least one nutritional ingredient other than isolated and/or enlarged oleosomes, wherein the isolated and/or enlarged oleosomes have an average globule diameter in a range of from 2.0 to 12.0 micron. The invention further relates to a process for preparing the nutritional composition.

### BACKGROUND OF THE INVENTION

Nutritional compositions are compositions that are developed to cover the nutritional needs, of specific groups of people, such as preterm infants, infants, toddlers, invalids, elderly people, athletes, or humans having nutritional deficiencies and/or having a deficient immune system.

Nutritional compositions may be in the form of a liquid, a powder, a pudding or a jelly, a cookie, a snack bar or in any other form. Often nutritional compositions are emulsions or require emulsification during its manufacturing. Typical emulsions have an average lipid globule diameter of less than 1 micron. Emulsifiers are needed to stabilize these emulsions. Emulsions with increasing lipid droplet size are difficult to stabilize. They will require complex emulsification systems and/or additional processing during manufacturing.

Natural occurring emulsions such as mother's milk have a globule droplet size of around 4 micron.

There is a need for mimicking such naturally occurring emulsions. There is a need for stable emulsions with an increased lipid globule diameter and without added emulsifiers.

The current invention provides such nutritional compositions and a process for preparing these compositions.

### SUMMARY OF THE INVENTION

The current invention relates to a nutritional composition comprising isolated and/or enlarged oleosomes and at least one nutritional ingredient other than isolated and/or enlarged oleosomes, wherein the isolated and/or enlarged oleosomes have an average globule diameter in a range of from 2.0 to 12.0 micron.

The invention further relates to a process for preparing the nutritional composition and the process is comprising the blending of the isolated and/or enlarged oleosomes with the at least one other nutritional ingredient other than isolated and/or enlarged oleosomes, and characterized in that the isolated and/or enlarged oleosomes are in powder or liquid form.

### DETAILED DESCRIPTION

The current invention relates to a nutritional composition comprising isolated and/or enlarged oleosomes and at least one nutritional ingredient other than isolated and/or enlarged oleosomes, wherein the isolated and/or enlarged oleosomes have an average globule diameter in a range of from 2.0 to 12.0 micron.

Nutritional compositions according to the invention are compositions that are developed to cover the nutritional needs. The people that are targeted for the nutritional composition according to the invention relate to specific groups of people, such as, but not limited to, preterm infants, infants, toddlers, invalids, elderly people, athletes, or humans having nutritional deficiencies and/or having a deficient immune system. They may be designed for people suffering a more specific disease state such as cancer, chronic obstructive pulmonary disease, and later-stage kidney disease and others. Amongst others, nutritional compositions may be helpful for people who struggle with a loss of appetite, have difficulty in chewing, have trouble preparing balanced meals, and/or are recovering from surgery or an illness. In the event that the nutritional composition is meant for a complete nutrition, it can provide a healthy balance of protein, carbohydrate, and/or fat.

The nutritional compositions according to the invention may be in the form of a liquid, as a ready-to-drink nutritional composition, or used in feeding tubes. It can also be in the form of a formula base, i.e. a powder or a concentrated liquid, to be dissolved in water or in another fluid for the preparation of a ready-to-drink nutritional composition. The nutritional composition may also be in the form of a pudding or a jelly, or in the form of a cookie or a snack bar, or in any other form. Preferably the nutritional composition is a ready-to-drink nutritional composition, or a powder.

“Oleosomes”, as such also known as “oil bodies”, “lipid bodies”, “lipid droplets” or “spherosomes”, are pre-emulsified droplets or vesicles of oil that are present in cells.

The “isolated oleosomes” and/or “enlarged oleosomes” of the nutritional composition are directly obtainable by extraction and/or isolation of oleosomes, and/or obtainable by enlarging the diameter of the isolated oleosomes.

The terms “isolated oleosomes” and “enlarged oleosomes” encompass oleosomes isolated from a single oleosome source as well as blends of oleosomes that are isolated from more than one oleosomes source.

The isolated and/or enlarged oleosomes of the nutritional composition according to the present invention have an average globule diameter (D50 value) in a range of from 2.0 to 12.0 micron, from 2.5 to 11.0 micron, from 3.0 to 10.0 micron, from 3.5 to 9.0 micron, from 4.5 to 8.0 micron, or from 5.0 to 7.0 micron, 5.5 to 6.0 micron.

The D50-value of oleosomes is the diameter below which 50% of the volume of oleosome particles lies, and it is expressed in micron (=micrometer, symbol: μm). D90-value of oleosomes is the diameter below which 90% of the volume of oleosome particles lies. D10-value of oleosomes is the diameter below which 10% of the volume of oleosome particles lies.

To measure the average globule diameter (D50 value) of the isolated and/or enlarged oleosomes, the oleosomes are considered spherical and in case of non-spherical oleosomes, the diameter is considered as being the largest dimension that can be measured between two opposite points on the surface thereof.

To be able to measure the globule diameter of the isolated and/or enlarged oleosomes with a Mastersizer 3000 from Malvern, the isolated and/or enlarged oleosomes need to be diluted such that an obscuration in the range of from 8 to 8.5% is obtained. Obscuration within the Mastersizer is the amount of light blocked or scattered, by the particles. Therefore, the isolated and/or enlarged oleosomes are diluted in a buffer solution containing 10 mM sodium phosphate, pH 7.4, and 1.0 weight % sodium dodecyl sulphate (SDS). To give some guidance, about 0.2 wt % of isolated and/or enlarged oleosomes is diluted in the buffer solution and dilution is further adjusted to obtain the aforementioned obscuration. Once this optimal obscuration is obtained, the globule diameter is measured and the average globule diameter (D50) can be calculated. The actual method applied in the current application is provided in detail in the section “examples: measurement of average globule size”

The isolated and/or enlarged oleosomes (or lipid droplets) of the nutritional composition are sourced from plant cells, fungal cells, yeast cells, bacterial cells or algae cells.

More specifically, the isolated and/or enlarged oleosomes of the nutritional composition are obtained from cells from pollens, spores, seeds or vegetative plant organs in which oleosomes or oleosomes-like organelles are present. Preferably, the sources of origin of the isolated and/or enlarged oleosomes are members of the Brassicaceae, Amaranthaceae, Asparagaceae, Echium, Glycine, Astaraceae, Fabaceae, Malvaceae, Faboidae, Aracaceae, Euphorbiceae, Sinapsis, Lamiaceae, Cyperaceae, Anacardiaceae, Rosaceae, Betulaceae, Juglandaceae, Oleaceae, Lauraceae, Sapotaceae and/or Poaceae families. More preferably, the isolated and/or enlarged oleosomes are obtained from a plant seed and most preferably from the group of plant species comprising: rapeseed (Brassica spp.), soybean (Glycine max), sunflower (Helianthus annuits), oil palm (Elaeis guineeis), cottonseed (Gossypium spp.), groundnut (Arachis hypogaea), coconut (Cocus nucifera), castor (Ricinus communis), safflower (Carthamus tinctorius), mustard (Brassica spp. and Sinapis alba), coriander (Coriandrum sativum), squash (Cucurbita maxima), linseed/flax (Linum usitatissimum) (including brown (also called bronze) and yellow (also called gold) linseed), Brazil nut (Bertholletia excelsa), hazelnut (Corylus avellana), walnut (Juglands major), jojoba (Simmondsia chinensis), thale cress (Arabidopsis thaliana), wheat and wheat germ (Triticum spp.), maize and maize germ (Zea mays), amaranth (family of Amaranthus), sesame (Sesamum indicum), oat (Avena sativa), camelina (Camelina sativa), lupin (Lupinus), peanut (Arachis hypogaea), quinoa (Chenopodium quinoa), chia (Salvia hispanica), yucca, almond (Prunus dulcis), cashew (Anacardium occidentale), olive (Olea), avocado (Persea americana), shea (Butyrospermum parkii), cocoa bean (Theobroma cacao), argan (Argania spinosa), rice, their corresponding mid or high oleic varieties and any variety with increased level of unsaturated fatty acids compared to the original seed variety. Varieties may be obtained by natural selection or by genetic modification (GMO).

The isolated and/or enlarged oleosomes of the nutritional composition may be obtained from a vegetable source selected from the group consisting of rapeseed, soybean, sunflower, mid and high oleic sunflower, cottonseed, coconut, brown linseed, yellow linseed, hazelnut, maize, sesame, almond, cashew, olive, avocado and shea. The isolated and/or enlarged oleosomes may be obtained from a vegetable source selected from the group consisting of rapeseed, sunflower, mid and high oleic sunflower, soybean, coconut, brown linseed, yellow linseed and hazelnut. Preferably, the isolated and/or enlarged oleosomes are obtained from a vegetable source selected from the group consisting of rapeseed, sunflower, high oleic sunflower, soybean, brown linseed and yellow linseed.

The isolated and/or enlarged oleosomes comprise proteins such as, but not limited to, “intrinsic proteins”. Said intrinsic proteins are mostly oleosin. Caleosin and stereolosin are minor intrinsic proteins. The oleosins contain a hydrophilic part, which is present at the oleosomes' surface and a hydrophobic part which is anchored in the oil and ensures for oleosome stability. Even at alkaline conditions of pH 8 or higher, proteins remain strongly bound, whereas weakly bound proteins will be removed in alkaline conditions.

In one aspect of the invention the isolated and/or enlarged oleosomes of the nutritional composition comprise proteins in an amount of from 0.2 to 6.0 weight %, from 0.3 to 5.5 weight %, or from 0.3 to 5.2 weight % expressed on dry weight of isolated and/or enlarged oleosomes.

The content of the proteins is measured after washing isolated and/or enlarged oleosomes at pH 9.5. The actual applied method is described in the experimental section.

In another aspect of the invention the isolated and/or enlarged oleosomes of the nutritional composition comprise phospholipids in an amount of from 0.2 to 6.0 weight %, from 0.3 to 5.5 weight %, from 0.4 to 5.0 weight.

In a further aspect of the invention the isolated and/or enlarged oleosomes of the nutritional composition comprise proteins in an amount of from 0.2 to 6.0 weight %, from 0.3 to 5.5 weight %, or from 0.3 to 5.2 weight % expressed on dry weight of isolated and/or enlarged oleosomes and phospholipids in an amount of from 0.2 to 6.0 weight %, from 0.3 to 5.5 weight %, from 0.4 to 5.0 weight %, expressed on dry weight of isolated and/or enlarged oleosomes. The content of the proteins is measured after washing isolated and/or enlarged oleosomes at pH 9.5.

In another aspect of the invention, the isolated and/or enlarged oleosomes are not from an animal source.

The methods for obtaining isolated oleosomes are well known in the art.

Typically, seeds are harvested and, if desired, materials such as stones or seed hulls (de-hulling) may be removed from the seeds by, for example, sieving or rinsing. Subsequently the seeds are processed by mechanical pressing, grinding or crushing. A liquid phase, e.g. water, may also be added prior to grinding of the seeds, which is known as wet milling.

Following grinding, a slurry is obtained and separated into a liquid and a solid phase Separation may be obtained by means of filtration or centrifugation. The liquid phase may be subsequently separated by applying centrifugal acceleration which separates the liquid phase further into two liquid phases, a hydrophilic phase and a hydrophobic oleosome containing phase. Without being limited, a centrifugal decanter may be used for the centrifugation.

Alternatively, the slurry obtained after grinding may be submitted to a liquid-solid-liquid separation (three-phase separation) using a centrifugal tricanter. This separation technique follows the same operating principle.

The thus obtained isolated oleosomes may be further subjected to a dehydration and/or concentration step. Dehydration steps, well known to the person skilled in the art, are amongst others spray drying, fluid bed drying, freeze drying or vacuum drying. In one aspect of the invention, the dehydration step is a spray-drying step. Concentration steps include, without limitation, ultrafiltration, falling film evaporation or reversed osmosis. The thus obtained oleosomes are called dehydrated and/or concentrated oleosomes and are present in a more concentrated form or a powder form of the isolated oleosomes.

“Enlarged oleosomes” are isolated oleosomes that have been subsequently subjected to any process whereby the average globule diameter of the isolated oleosomes is increased. Processes for obtaining enlarged oleosomes may include, but are not limited to, a process of applying high-shear centrifugational force to the isolated oleosomes and/or a process of applying high-shear mixing to the isolated oleosomes.

Isolated oleosomes in powder form are re-suspended in an aqueous solution prior to the process for obtaining enlarged oleosomes.

Preferably, the process for obtaining enlarged oleosomes is using high-shear mixing, which allows to recover enlarged oleosomes in high yields. This process comprises the steps of:
a) Providing isolated oleosomes with a dry substance in a range of from 30 to 80% weight %, and
b) Subjecting the isolated oleosomes from step a) to a high-shear mixing, and obtaining enlarged oleosomes.

The isolated oleosomes provided in step a) of the process for obtaining enlarged oleosomes, have a dry substance content in a range of from 30 to 80 weight %. They further can have a dry substance in the range of from 40 to 70 weight %, or a dry substance in the range of from 50 to 60 weight %.

In step b) of the process for obtaining enlarged oleosomes, the isolated oleosomes may be subjected to a high-shear mixing.

High-shear mixing is commonly applied to reduce the size of the lipid globules in emulsions. Surprisingly it is found that applying high-shear mixing to the isolated oleosomes results in obtaining enlarged oleosomes that have an increased average globule diameter compared to the average globule diameter of the isolated oleosomes applied in step a).

High-shear mixing may be applied by means of different types of high-shear mixers. They can be static high-shear mixers or dynamic mixers, e.g. rotor-stator high-shear mixers. Different types of high-shear rotor-stator mixers exist such as batch and in-line high-shear rotor-stator mixers.

The high-shear mixing in step b) of the process for obtaining enlarged oleosomes may be applied by means of a rotor-stator high-shear mixer.

These types of mixers can be characterized by their tip velocity. The tip velocity or circumferential speed is the speed of the fluid at the outside diameter of the rotor and is expressed in meter per second (m/s). The tip velocity will be higher than the velocity at the centre of the rotor, and it is this velocity difference that creates shear. The tip velocity can be calculated for each rotor-stator high-shear mixer type based on the diameter of the rotor and its rotational speed. Further design factors include the diameter of the rotor and its rotational speed, the distance between the rotor and the stator, the time in the mixer. Still further design factors may include the number of rows of teeth on the rotor, their angle, the width of the openings between the teeth and the number of impellers in the rotor stator high shear mixer.

The high-shear mixing in step b) of the process is applied at temperatures of from 4 to 50° C., from 10 to 35° C., or from 15 to 30° C.

The high-shear mixing in step b) of the process for obtaining enlarged oleosomes may be applied by means of a rotor-stator high-shear mixer at a tip velocity in a range of from 1.6 to 12.8 m/s, in a range of from 1.9 to 11.2 m/s, from 2.6 to 9.6 m/s, from 3.2 to 8.0 m/s, from 3.5 to 8.5 m/s, from 4.5 to 7.5 m/s or of from 4.8 to 6.4 m/s.

The high-shear mixing in step b) of the process for obtaining enlarged oleosomes may be applied for a period of time of at least 2 minutes, at least 3 minutes, at least 5 minutes, or at least 7 minutes. The high-shear mixing in step b) of the process may be applied for a period of time in a range of from 2 to 90 min, in a range of from 3 to 60 min, from 4 to 45 min.

Preferably, the high-shear mixing in step b) of the process for obtaining enlarged oleosomes may be applied by means of a high-shear mixer at a tip velocity in a range of between 3.5 to 8.5 m/s for a period of time of at least 3 minutes. Preferably, the process is applied by means of a high-shear mixer at a tip velocity in a range of between 4.5 to 7.5 m/s for a period of time of at least 4 minutes.

Alternatively, the high shear mixing in step b) of the process for enlarging oleosomes may be applied by means of an in-line static high-shear mixer.

The level of high-shear mixing obtained by an in-line static high-shear mixer may depend upon its design. The design of static mixers may consist of a series of baffles and/or orifices of different forms an sizes.

The isolated oleosomes may be subjected to a washing step prior to step b) of the process for obtaining enlarged oleosomes using high-shear mixing. The isolated oleosomes may for example be washed by re-suspending them in a floatation solution of lower density (e.g. water, aqueous buffer with neutral to alkaline pH up to 9.5, up to 10 or up to 11 and by subsequently separating them again from the aqueous phases by means of centrifugation. The washing procedure may be repeated several times, from one up to three times.

It is found that one, up to three, washing steps prior to step b), may result in a further enlargement of the average globule diameter of the oleosomes during the step b) of the current process. The tip velocity and the time of high-shear mixing applied in step b) may be reduced when the isolated oleosomes are washed prior to step b) and still a similar D50 value will be obtained.

The isolated oleosomes may be subjected to a heat treatment prior to step b) of the process for obtaining enlarged oleosomes using high-shear mixing. The heat treatment may be a pasteurization treatment or an ultra-high-temperature (UHT) treatment. Pasteurization treatment involves heating the oleosomes at a temperature of 65° C. to 70° C. for 30 minutes in batch or 80° C. to 85° C. for 15 to 25 seconds in a continuous-flow process (High temperature short time Pasteurization (HTST pasteurization)). UHT treatment involves heating of oleosomes at a temperature of 135° C. to 150° C. in a continuous-flow process and holding at that temperature for one or more seconds, up to 5 seconds, before cooling rapidly to room temperature

It is found that such a heat treatment of the isolated oleosomes may result in a further enlargement of the average globule diameter of the oleosomes during the step b) of the process. The tip velocity and the time of high-shear mixing applied in step b) may be reduced when the isolated oleosomes are heat treated prior to step b) and still a similar D50 value will be obtained.

The pH of the isolated oleosomes that are subjected to step b) of the process for obtaining enlarged oleosomes using high-shear mixing is in a range of from 3.5 to 10.0, from pH 4.5 to 8.5, from pH 5.5 to 7.5. The pH of the isolated oleosomes may be adjusted according to needs using sodium hydroxide, sodium bicarbonate hydrogen chloride, citric acid, lactic acid, acetic acid or aqueous buffer solutions and the like.

It is found that this pH range of isolated oleosomes may positively influence the further enlargement of the average globule diameter of the oleosomes during the step b) of the current process. The tip velocity and the time of high-shear mixing applied in step b) may be reduced when the isolated oleosomes are in the described pH range, preferably from 5.5 to 7.5 prior to step b) and still a similar D50 value will be obtained

The high-shear mixing in step b) of the process for obtaining enlarged oleosomes using high-shear mixing may be applied under such conditions that contact of the oleosomes with oxygen is reduced. High-shear mixing may be applied in presence of nitrogen or under vacuum. This may further improve the oxidation stability of the obtained enlarged oleosomes.

In a more specific aspect of the invention, the high-shear mixing in step b) of the process is applied to isolated, washed oleosomes sourced from sunflower, mid-oleic sunflower or high-oleic sunflower that were adjusted to a pH in a range of from 6 to 7 and a dry matter content in a range of from 45 to 50% prior to high-shear mixing, and the high-shear mixing is applied for 5.5 to 6.5 minutes, at a tip velocity of 7.3 to 7.9 m/s.

The enlarged oleosomes obtained from step b) of the process using high-shear mixing may be further subjected to a heat treatment step. The heat treatment may be a pasteurization treatment or an ultra-high-temperature (UHT) treatment. Pasteurization treatment involves heating the enlarged oleosomes at a temperature of 65° C. to 70° C. for 30 minutes in batch or 80° C. to 85° C. for 15 to 25 seconds in a continuous-flow process (High temperature short time Pasteurization (HTST pasteurization)). UHT treatment involves heating of oleosomes at a temperature of 135° C. to 150° C. in a continuous-flow process and holding at that temperature for one or more seconds, up to 5 seconds, before cooling rapidly to room temperature.

The heat treatment step of the enlarged oleosomes obtained in step b) of the process is applied to further avoid microbial contamination of the oleosomes. It has been found that the enlarged oleosomes maintain their average globule diameter when being subjected to such a heat treatment step. Therefore, the enlarged oleosomes may be preserved for a longer period without addition of any preservatives.

The enlarged oleosomes obtained from step b) of the process using high-shear mixing may be further subjected to a dehydration step. Dehydration steps well known to the person skilled in the art are amongst others spray drying, fluid bed drying, freeze drying or vacuum drying. In one aspect of the invention, the dehydration step is a spray-drying step. Dehydration of the oleosomes takes place in the presence of from 10 to 45 weight %, from 15 to 40 weight %, from 20 to 35 weight % of a carrier material such as, but not limited to, maltodextrin, lactose, proteins from vegetal and/or animal origin, or any combination of two or more thereof. Advantageously, the oleosomes may be dehydrated in the presence of proteins obtained from the same vegetable source as the oleosomes.

It has been found that the enlarged oleosomes are stable in terms of average globule size when being subjected to a spray drying step. The stability of the spray-dried oleosomes may be observed by the D10, D50 and/or D90 value of the oleosomes that remains practically constant versus the D10, D50 and/or D90 value of the oleosomes prior to spray-drying. Typically, D50-values will not change with more than 15%, more than 12%, or more than 10% after spray-drying of the oleosomes.

Spray-drying allows for a convenient packaging of the enlarged oleosomes and storage at room temperature. It also facilitates the dosing of enlarged oleosomes as ingredients in the preparation of further products.

In one aspect of the invention, the isolated and/or enlarged oleosomes in the nutritional composition may be present in an amount of from 1 to 70 weight %, from 5 to 65 weight %, from 10 to 60 weight %, from 12 to 58 weight %, from 15 to 55 weight %, from 20 to 50 weight %, or from 25 to 45 weight % on dry matter of the nutritional composition. Preferably, the isolated and/or enlarged oleosomes in the nutritional composition may be present in an amount of from 12 to 70 weight %, from 15 to 65 weight %, from 20 to 60 weight %, or from 25 to 58 weight % on dry matter of the nutritional composition.

The nutritional composition according to the invention comprises at least one nutritional ingredient other than isolated and/or enlarged oleosomes. The at least one nutritional ingredient is not derived from isolated and/or enlarged oleosomes. Nutritional ingredients are ingredients that contribute to the caloric intake and/or provide micronutrients. Nutritional ingredients comprise sources of proteins, sources of fats, sources of carbohydrates and/or sources of micronutrients such as, but not limited to, vitamins, minerals, trace elements, essential amino acids or essential fatty acids. These sources do not comprise isolated and/or enlarged oleosomes.

In one more aspect of the invention, the at least one other nutritional ingredient is selected from the group of proteins, carbohydrates, fats, minerals, trace elements, essential amino acids, essential fatty acids, vitamins, or a mixture of two or more thereof. Preferably, the at least one other nutritional ingredient is selected from the group of proteins, carbohydrates, fats, essential amino acids, essential fatty acids, vitamins, or a mixture of two or more thereof.

Sources of proteins may be from plant and/or animal origin. Protein sources from animal origin include, but are not limited to, lean meat, poultry, fish, eggs or dairy products like milk, yoghurt, cheese, whey proteins or caseinate. Protein sources from vegetable origin include, without any limitation, seeds, nuts, beans, legumes, such as lentils and chickpeas, grain and cereal-based products. Further examples of protein sources from vegetable origin are soy protein and pea protein

Sources of proteins may also be in form of protein isolates.

The at least one other nutritional ingredient may be sources of fats in the form of “free fats”. Free fats are defined as fats not contained within isolated and/or enlarged oleosomes

Sources of such “free fats” may be from plant and/or animal origin or a combination thereof. Sources of these fats from animal origin include, but are not limited to milk fat, pork fat (lard), cattle and sheep fat (tallow), poultry fat and two or more combinations thereof

Fat sources of these“free fats” from vegetable origin include, without any limitation, cocoa butter, corn oil, cottonseed oil, groundnut oil, linseed oil, olive oil, palm, including palm olein, palm stearin, rapeseed oil, rice bran oil, safflower oil (also known as flaxseed oil), sesame oil, soybean oil, sunflower oil, including mid- and high-oleic varieties of sunflower, coconut oil, palm kernel oil, MCT compositions (i.e. Medium Chain Triglyceride with fatty acid chain lengths in range of C8 to C12) and combinations of two or more thereof. Fats or fat combinations may be selected to obtain the desired composition of fatty acids in the nutritional composition, especially the desired amount of mono- and poly-unsaturated fatty acids.

Sources of carbohydrates may be mono-saccharides, disaccharides, oligosaccharides, and polysaccharides, their corresponding polyols and combinations of two or more thereof.

Monosaccharides include glucose, fructose, xylose or galactose. Non-limiting examples of di-saccharides, such as maltose, saccharose, lactose, isomaltulose and mixtures of two or more thereof.

Examples of suitable polyols may include, sorbitol, mannitol, xylitol, erythritol, lactitol, mixtures of two or more thereof and the like.

Oligosaccharides are saccharide polymers containing a small number, typically three to ten, monosaccharides. Non limiting examples of oligosaccharides are Fructo-oligosaccharides (FOS) and Galacto-oligosaccharides (GOS), xylo-oligosaccharides (XOS), arabino-xylo-oligosaccharides (AXOS), manno-oligo-saccharides (MOS), and mixtures of two or more thereof

Polysaccharides comprise soluble and insoluble fibers. Polysaccharides can be glucose polymers such as starch and starch-derivatives, fructans derived from chicory or inulin, polydextrose, agar, galactomannans such as guar gum and locust bean gum, pectin, pectin derivatives, seaweed derived polysaccharides such as carrageenan, resistant starches, cereal fibres, fruit fibres and fibres of legumes, oat fibers and the like.

Vitamins are essential micronutrients that an organism needs in small quantities for the proper functioning of its metabolism. Essential nutrients cannot be synthesized in the organism, either at all or not in sufficient quantities, and therefore must be obtained through the diet. Vitamins required by human metabolism are vitamin A, including all-trans-retinol, all-trans-retinyl-esters, as well as all-trans-beta-carotene and other provitamin A carotenoids, vitamin B1 (thiamine), vitamin B2 (riboflavin), vitamin B3 (niacin), vitamin B5 (pantothenic acid), vitamin B6 (pyridoxine), vitamin B7 (biotin), vitamin B9 (folic acid or folate), vitamin B12 (cobalamins), vitamin C (ascorbic acid), vitamin D (calciferols), vitamin E (tocopherols and tocotrienols), and vitamin K (quinones).

Minerals are chemical elements required as essential nutrients by organisms to perform functions necessary for life. The major minerals in the human body are calcium, phosphorus, potassium, sodium, and magnesium. The trace elements that have a specific biochemical function in the human body are sulfur, iron, chlorine, cobalt, copper, zinc, manganese, molybdenum, iodine, and selenium.

Essential amino acids are amino acids that cannot be synthesized de novo by the organism at a rate commensurate with its demand, and thus must be supplied in its diet. Examples of amino acids that cannot be synthesized by humans are phenylalanine, valine, threonine, tryptophan, methionine, leucine, isoleucine, lysine, and histidine.

The synthesis of other amino acids, such as arginine, cysteine, glycine, glutamine, proline, and tyrosine can be limited under special pathophysiological conditions, such as prematurity in the infant or individuals in severe catabolic distress.

Essential fatty acids are fatty acids that humans must ingest because the body requires them for good health but cannot synthesize them. Alpha-linolenic acid (an omega-3 fatty acid) and linoleic acid (an omega-6 fatty acid) are essential for humans. Further examples may include docosahexaenoic acid and gamma-linolenic acid.

The nutritional composition that is comprising beyond isolated and/or enlarged oleosomes at least one nutritional ingredient other than isolated and/or enlarged oleosomes has significant advantages such as flexibility and variability. The ratio of nutritional ingredients is not bound by the natural composition of oleosomes. It allows to adapt the composition according to the specific needs of the consumer.

In one more aspect of the invention the nutritional composition further comprises at least one non-nutritional ingredient.

Non-nutritional ingredients according to the invention are ingredients that do not substantially add to the caloric intake and/or do not substantially provide micronutrients. Examples of non-nutritional ingredients are flavors, colorants, emulsifiers, acid regulators such as citric acid or lactic acid, preservatives, and the like. The non-nutritional ingredients may be from a natural or synthetic origin.

In one preferred aspect of the invention, the nutritional composition does not contain ingredients from animal origin.

The nutritional composition according to the invention is targeted to people, such as, but not limited to, preterm infants, infants, toddlers, invalids, elderly people, athletes, or humans having nutritional deficiencies and/or having a deficient immune system.

In one preferred aspect of the invention, the nutritional composition is an infant formula.

The infant formula according to the invention is a nutritional composition to a formula-fed infant allowing the comparable growth and development as an exclusively breastfed infant. For this reason, the infant formulae must be carefully prepared to meet the infants' nutritionals needs, not only the main nutrients (proteins, lipids and carbohydrates), but also the trace elements (minerals, vitamins and etc.). In order to adapt gradually to the needs of growing infants, the composition of infant formulae must vary according to the age of the infant.

The infant formula according to the invention may be a first age infant formula, for infants from birth to age of 6 months, a follow-on formula (also called second age infant formula), for infants from an age of 6 to 18 months, or a growing-up formula (also called third age infant formula) for infants from an age from 1 to 3 years

In a specific aspect of the invention, the infant formula is a follow-on formula or growing-up formula.

The infant formula according to the invention may also be a preparation for special medical purposes such as, but not limited to, hypoallergenic formulae prepared from partially hydrolysed proteins, to prevent infants with a high risk of milk protein allergy having an allergic reaction and a soy-based formulae prepared with soy protein isolates, for infants with lactose intolerance and/or galactosemia or for infants who are allergic to cow's milk proteins. Further examples of infant formulae according to the invention prepared for special medical purposes are nutrient-dense formulae enhanced in proteins, fats, minerals and vitamins for premature infants or low-birth-weight and elemental formulae, using free amino acids instead of proteins or peptides, for infants who are allergic to hydrolysed protein or soy, and the like.

In one aspect of the invention, the infant formula comprises isolated and/or enlarged oleosomes with an average globule diameter in a range of from 2.0 to 12.0 micron, from 2.5 to 11.0 micron, from 3.0 to 10.0 micron, from 3.5 to 9.0 micron, from 4.5 to 8.0 micron, from 5.0 to 7.0 micron, 5.5 to 6.0 micron, from 5.6 to 5.9 micron, or from 5.7 to 5.8 micron.

In another aspect of the invention, the infant formula comprises isolated and/or enlarged oleosomes and at least one nutritional ingredient other than isolated and/or enlarged oleosomes, and the infant formula is characterized in that:
the isolated and/or enlarged oleosomes are present in a range of from 1 to 70 weight %, of from 5 to 65 weight %, from 12 to 58 weight %, from 15 to 55 weight %, from 20 to 50 weight %, or from 25 to 45 weight % on dry matter of the nutritional composition, and
the isolated and/or enlarged oleosomes have an average globule diameter in a range of from 2.0 to 12.0 micron, from 2.5 to 11.0 micron, from 3.0 to 10.0 micron, from 3.5 to 9.0 micron, from 4.5 to 8.0 micron, from 5.0 to 7.0 micron, 5.5 to 6.0 micron, from 5.6 to 5.9 micron, or from 5.7 to 5.8 micron, and
wherein the isolated and/or enlarged oleosomes have a content of proteins in an amount of from 0.2 to 6.0 weight %, from 0.3 to 5.5 weight %, or from 0.3 to 5.2 weight % expressed on dry weight of isolated and/or enlarged oleosomes.

In one aspect of the invention, the infant formula is characterized in that it has:
a protein content in a range of from 1.8 to 2.8 g per 100 kcal, from 1.9 to 2.5 g per 100 kcal, from 2.0 to 2.1 g per 100 kcal,
a carbohydrate content in a range of from 9.0 to 14.0 g per 100 kcal, from 10.0 to 12.0 g per 100 kcal,
a lipid content in a range of from 4.4 to 6.0 g per 100 kcal, from 4.5 to 5.9 g per 100 kcal,
wherein at least 40% or more, at least 50% or more, at least 60% or more, at least 70% or more, at least 80% or more, at least 90% or more of the lipid content is present as isolated and/or enlarged oleosomes.

In one more aspect of the invention, the infant formula is characterized in that it has:
a protein content in a range of from 1.8 to 2.8 g per 100 kcal, from 1.9 to 2.7 g per 100 kcal, from 2.0 to 2.6 g per 100 kcal, from 2.1 to 2.5 g per 100 kcal,
a carbohydrate content in a range of from 9.0 to 14.0 g per 100 kcal, from 10.0 to 13.0 g per 100 kcal,
a lipid content in a range of from 4.4 to 6.0 g per 100 kcal, from 4.5 to 5.9 g per 100 kcal, from 4.6 to 5.8 g per 100 kcal, from 4.7 to 5.8 g per 100 kcal, from 4.8 to 5.7 g per 100 kcal, from 4.9 to 5.6 g per 100 kcal, from 5.0 to 5.5 g per 100 kcal,
wherein at least 40% or more, at least 50% or more, at least 60% or more, at least 70% or more, at least 80% or more, at least 90% or more of the lipid content is present as isolated and/or enlarged oleosomes, and
wherein the isolated and/or enlarged oleosomes have an average globule diameter in a range of from 2.0 to 12.0 micron, from 2.5 to 11.0 micron, from 3.0 to 10.0 micron, from 3.5 to 9.0 micron, from 4.5 to 8.0 micron, from 5.0 to 7.0 micron, 5.5 to 6.0 micron, from 5.6 to 5.9 micron, or from 5.7 to 5.8 micron, and,
wherein the isolated and/or enlarged oleosomes have a content of proteins in an amount of from 0.2 to 6.0 weight %, from 0.3 to 5.5 weight %, or from 0.3 to 5.2 weight % expressed on dry weight of isolated and/or enlarged oleosomes.

In yet another aspect of the invention, the infant formula is characterized in that it has:
a protein content in a range of from 1.8 to 2.8 g per 100 kcal, from 1.9 to 2.5 g per 100 kcal, from 2.0 to 2.1 g per 100 kcal,
a carbohydrate content in a range of from 9.0 to 14.0 g per 100 kcal, from 10.0 to 12 g per 100 kcal,
a lipid content in a range of from 4.4 to 6.0 g per 100 kcal, from 4.5 to 5.9 g per 100 kcal,
wherein at least 40% or more, at least 50% or more, at least 60% or more, at least 70% or more, at least 80% or more, at least 90% or more, and
wherein the isolated and/or enlarged oleosomes have an average globule diameter in a range of from 2.0 to 12.0 micron, from 2.5 to 11.0 micron, from 3.0 to 10.0 micron, from 3.5 to 9.0 micron, from 4.5 to 8.0 micron, from 5.0 to 7.0 micron, 5.5 to 6.0 micron, from 5.6 to 5.9 micron, or from 5.7 to 5.8 micron, and
   wherein the isolated and/or enlarged oleosomes have a content of proteins in an amount of from 0.2 to 6.0 weight %, from 0.3 to 5.5 weight %, or from 0.3 to 5.2 weight % expressed on dry weight of isolated and/or enlarged oleosomes and
   wherein the isolated and/or enlarged oleosomes are sourced from sunflower, mid-oleic sunflower or high-oleic sunflower.

Alternatively, the infant formula, in particular a preterm and/or catch-up formula, is characterized in that it has:
a protein content in a range of from 2.1 to 4.1 g per 100 kcal, from 2.4 to 3.8 g per 100 kcal, from 2.8 to 3.4 g per 100 kcal,
a carbohydrate content in a range of from 10.0 to 12.0 g per 100 kcal,
a lipid content in a range of from 4.4 to 6.0 g per 100 kcal, from 4.5 to 5.9 g per 100 kcal,
   wherein at least 40% or more, at least 50% or more, at least 60% or more, at least 70% or more, at least 80% or more, at least 90% or more of the lipid content is present as isolated and/or enlarged oleosomes.

Alternatively, the infant formula, in particular a preterm and/or catch-up formula, is characterized in that it has:
a protein content in a range of from 2.1 to 4.1 g per 100 kcal, from 2.4 to 3.8 g per 100 kcal, from 2.8 to 3.4 g per 100 kcal,
a carbohydrate content in a range of from 10.0 to 12.0 g per 100 kcal,
a lipid content in a range of from 4.4 to 6.0 g per 100 kcal, from 4.5 to 5.9 g per 100 kcal,
wherein at least 40% or more, at least 50% or more, at least 60% or more, at least 70% or more, at least 80% or more, at least 90% or more of the lipid content is present as isolated and/or enlarged oleosome, and
wherein the isolated and/or enlarged oleosomes have an average globule diameter in a range of from 2.0 to 12.0 micron, from 2.5 to 11.0 micron, from 3.0 to 10.0 micron, from 3.5 to 9.0 micron, from 4.5 to 8.0 micron, from 5.0 to 7.0 micron, 5.5 to 6.0 micron, from 5.6 to 5.9 micron, or from 5.7 to 5.8 micron, and
wherein the isolated and/or enlarged oleosomes have a content of proteins in an amount of from 0.2 to 6.0 weight %, from 0.3 to 5.5 weight %, or from 0.3 to 5.2 weight % expressed on dry weight of isolated and/or enlarged oleosomes.

Alternatively, the infant formula is characterized in that it has:
a protein content in a range of from 2.1 to 4.1 g per 100 kcal, from 2.4 to 3.8 g per 100 kcal, from 2.8 to 3.4 g per 100 kcal,
a carbohydrate content in a range of from 10.0 to 12.0 g per 100 kcal,
a lipid content in a range of from 4.4 to 6.0 g per 100 kcal, from 4.5 to 5.9 g per 100 kcal,
wherein at least 60% or more, at least 70% or more, at least 80% or more of the lipid content is present as isolated and/or enlarged oleosomes, and
wherein the isolated and/or enlarged oleosomes have an average globule diameter in a range of from 2.0 to 12.0 micron, from 2.5 to 11.0 micron, from 3.0 to 10.0 micron, from 3.5 to 9.0 micron, from 4.5 to 8.0 micron, from 5.0 to 7.0 micron, 5.5 to 6.0 micron, from 5.6 to 5.9 micron, or from 5.7 to 5.8 micron, and
wherein the isolated and/or enlarged oleosomes have a content of proteins in an amount of from 0.2 to 6.0 weight %, from 0.3 to 5.5 weight %, or from 0.3 to 5.2 weight % expressed on dry weight of isolated and/or enlarged oleosomes, and
wherein the isolated and/or enlarged oleosomes are sourced from sunflower, mid-oleic sunflower or high-oleic sunflower.

In a more specific aspect of the invention, the infant formula comprises on total dry matter
skimmed milk powder in a range of from 10.0 to 18.0 weight %, from 12.0 to 16.5 weight % or from 13.5 to 15.5 weight %,
demineralized whey powder in a range of from 32.0 to 45.0 weight %, from 35.0 to 43.0 weight %, or from 37.0 to 41.0 weight %,
lactose in a range of from 15.0 to 23.0 weight %, from 17.0 to 21.5 weight %, of from 18.5 to 20.5 weight %, and
isolated and/or enlarged oleosomes in a range of from 20 to 34 weight %, from 22 to 32 weight %, or from 25 to 29 weight %,
wherein the isolated and/or enlarged oleosomes have an average globule diameter in a range of from 2.0 to 12.0 micron, from 2.5 to 11.0 micron, from 3.0 to 10.0 micron, from 3.5 to 9.0 micron, from 4.5 to 8.0 micron, from 5.0 to 7.0 micron, 5.5 to 6.0 micron, from 5.6 to 5.9 micron, or from 5.7 to 5.8 micron, and
wherein the isolated and/or enlarged oleosomes have a content of proteins in an amount of from 0.2 to 6.0 weight %, from 0.3 to 5.5 weight %, or from 0.3 to 5.2 weight % expressed on dry weight of isolated and/or enlarged oleosomes, and
wherein the isolated and/or enlarged oleosomes are sourced from sunflower, mid-oleic sunflower or high-oleic sunflower.

Infant formulae, whether in liquid form or subsequently spray-dried into powder, are in the form of an emulsion of lipid globules into an aqueous matrix. The average globule diameter of oil droplets in the emulsion of existing and known in the art infant formulae is less than about 1 micron. Lipid globules present in mother's milk, however, have an average globule diameter of at least 4 micron. Existing emulsions with such large lipid globules that try to mimic the average globule diameter of mother's milk are difficult to stabilize and require additional emulsifiers or stabilizers. The current invention provides infant formulae comprising the isolated and/or enlarged oleosomes with an average globule diameter that closely mimics the lipid globule diameter of mother's milk. These infant formulae according to the invention do not require additional emulsifiers and/or stabilizers, or at least their amount can be reduced.

It has been found that the average globule diameter of the isolated and/or enlarged oleosomes in the infant formula according to the present invention remains substantially unchanged after production of the infant formula. The stability of the isolated and/or enlarged oleosomes in the infant formula according to the present invention may be observed by measuring the D50-value of the isolated and/or enlarged oleosomes before and after production of infant formula. Typically, D50 will not change with more than 15% during production of the infant formula.

Additionally, it has been found that the average globule diameter of the isolated and/or enlarged oleosomes of the infant formula according to the present invention remains substantially unchanged during storage of the infant formula over time.

The invention further relates to a process for preparing the nutritional composition and the process is comprising the blending of the isolated and/or enlarged oleosomes with the at least one other nutritional ingredient other than isolated and/or enlarged oleosomes, and characterized in that the isolated and/or enlarged oleosomes are in powder or liquid form.

Isolated and/or enlarged oleosomes in powder form are dehydrated oleosomes. These dehydrated oleosomes are isolated and/or enlarged oleosomes that have been subjected to a dehydration step in the presence of a carrier material such as, without any limitation, maltodextrin, lactose, proteins of vegetable and/or animal origin or any combination of two or more thereof. Dehydration steps well known to the person skilled in the art are amongst others spray drying, fluid bed drying, freeze drying or vacuum drying. In one aspect of the invention, the dehydration step is a spray-drying step.

In the blending of the process according to the invention the isolated and/or enlarged oleosomes are mixed with the at least one other nutritional ingredient other than isolated and/or enlarged oleosomes. This other nutritional ingredient other than isolated and/or enlarged oleosomes is in powder form or liquid form.

Whereas traditional processes for preparing nutritional compositions will require an emulsification or homogenization step, the process of the current invention for preparing the nutritional composition does not need such a homogenisation or emulsification step. A simple blending of the isolated and/or enlarged oleosomes composition with the other nutritional ingredients is sufficient.

Optionally, the isolated and/or enlarged oleosomes and the at least one other nutritional ingredient is further blended with at least one non-nutritional ingredient.

In one aspect of the invention, the process for preparing the nutritional composition is comprising the blending of the isolated and/or enlarged oleosomes with the at least one other nutritional ingredient other than isolated and/or enlarged oleosomes, and characterized in that the isolated and/or enlarged oleosomes are:
i) from a vegetable source and with a dry substance in a range of 30 to 80 weight %, and
ii) washed one up to three times, and adjusted to a pH range of from 4.5 to 8.5, and
iii) heat treated by means of a UHT treatment, and
iv) subjected during a period between 2 to 90 min to a high-shear mixing by means of a rotor-stator high-shear mixer at a tip velocity in a range of from 1.6 to 12.8 m/s, and
v) heat treated by means of UHT treatment
vi) dehydrated in the presence of a carrier material.

In one aspect of the invention, the process for preparing the nutritional composition is comprising the blending of the isolated and/or enlarged oleosomes with the at least one other nutritional ingredient other than isolated and/or enlarged oleosomes, and characterized in that the isolated and/or enlarged oleosomes are:
i) from a vegetable source and with a dry substance in a range of 30 to 80 weight %, and
ii) washed one up to three times, and adjusted to a pH range of from 4.5 to 8.5, and
iii) heat treated by means of a UHT treatment, and
iv) subjected during a period between 2 to 90 min to a high-shear mixing by means of a rotor-stator high-shear mixer at a tip velocity in a range of from 1.6 to 12.8 m/s, and
v) heat treated by means of UHT treatment.

### EXAMPLES

### Measurement of Average Globule Size

The isolated and/or enlarged oleosomes were re-dispersed or diluted in a buffer solution containing 10 mM sodium phosphate, pH 7.4, and 1.0% sodium dodecyl sulphate (SDS). The average globules size, expressed as the D50 value, was measured using a Malvern Mastersizer 3000 equipped with a Hydro module. The concentration of the oleosomes in the buffer is such that an obscuration in the range of 8 to 8.5% in the Mastersizer equipment was obtained. A refractive index of 1.47 was used to measure the oleosomes size.

### Measurement of the Protein Content

After the first centrifugation step of the isolation procedure of oleosomes (see in example 1), sucrose (20% w/w) was added to the hydrophobic, oleosome containing, phase and the pH was adjusted to pH 9.5. The mixture was centrifuged again (15 000 g, 48° C., 3 h). This sequence of steps was repeated once more to remove any residual proteins that are weakly attached to the oleosomes. Finally, the washed oleosomes were dispersed in phosphate-buffered saline (PBS).

Prior to analysis of proteins, the dry weight of the purified oleosomes was determined using a precision moisture balance HR83 (Mettler Toledo, Geissen, Germany).

The protein content of the oleosomes was determined by the amount of Nitrogen in the sample.

This amount of Nitrogen is analyzed using a combustion method. Combustion of the sample is performed at 1100° C. The amount of Nitrogen is determined using a conductivity detector (LECO TruMAc). The protein content is calculated by multiplying the amount of Nitrogen analyzed by 6.25.

The content of proteins is expressed in weight % per dry weight of oleosomes washed at pH 9.5.

### Example 1: Isolation of Sunflower Oleosomes

100 g of dehulled sunflower seeds were soaked during 2 h in de-ionized water (ratio 1:3 seeds:water) at 4° C. The soaking water was discarded, and the soaked seeds were washed with de-ionized water (ratio 1:2 seed: demi-water). The washed seeds were grinded together with de-ionized water in a weight ratio of 1:10 of seeds/water. A Thermomix® TM5 (Vorwerk) was used for grinding at a speed of 10700 rpm for 90 sec. The obtained slurry of seeds and water was subsequently filtered over a nylon filter with a pore diameter of 80 μm. The pH of the obtained filtrate was adjusted to 7.5 with sodium hydroxide solution.

This filtrate was centrifuged for 30 minutes at 5000 rpm (4950×g, Thermo Scientific Sorvall Legend) to create a top layer. This is the first centrifugation step. The centrifugation process separates this liquid phase further into two liquid phases: a hydrophilic phase (supernatant) which was a watery solution of proteins, carbohydrates and soluble fibers and a hydrophobic phase (creamy top layer) which contained the desired oleosomes. In addition to the two liquid phases, a solid pellet that contained cell debris and insoluble proteins was obtained.

The scooped creamy top layer (oleosomes) was re-diluted with de-ionized water, brought to pH 9.5 and centrifuged for 30 minutes at 5000 rpm (4950×g, Thermo Scientific Sorvall Legend). The thus washed oleosomes (creamy top layer) were collected. The pH was adjusted to pH 6.7. The dry matter content was adjusted to 48%.

The amount of proteins of the isolated sunflower oleosomes was 2.12 weight % on dry weight of oleosomes and measured according to the previously described method, including washing at pH 9.5.

The average globule diameter of the sample (SFOB1) was measured and is shown in Table 1.

### Examples 2: Enlargement of Average Globule Size of Isolated Oleosomes

The sample of isolated oleosomes SFOB1 was subjected to a high-shear mixing process using an Ultra Turrax (IKA suitable for a sample volume of 1 to 50 ml). The Ultra Turrax had a rotor diameter of 6.1 mm, a stator diameter of 8 mm, a gap size of 0.25 mm and was equipped with a probe S25N-8G. The high-shear mixing was performed during 6 minutes at a rotational speed of 24000 rpm (corresponding to a tip velocity of 7.67 m/s). A sample SFOB2 was obtained. The average globule size is shown in table 1.

TABLE 1
Average globule size of oleosomes

| SFOB1 | SFOB2 |
|---|---|
| 2.37 micron | 5.65 micron |

The enlargement of the average globule size was clearly observed.

### Example 3: Infant Formula

Infant formulae were prepared according to the following recipe:

| | Expressed on | Expressed on |
|---|---|---|
| Ingredients | total weight | total dry matter |
| Skimmed milk powder: | 2.7% | 13.6% |
| Demineralizedwhey | 7.5% | 37.5% |
| powder: | | |
| Lactose: | 4.1% | 20.6% |
| Oleosomes (at dry matter | 12.0% | 28.3% |
| content of 48%): | | |
| Demineralized water: | 75.0% | |

The infant formulae were prepared by solubilizing the skimmed milk powder, demineralized whey powder and lactose into the demineralized water at 60° C. Oleosomes at room temperature were subsequently added to the mixture at 60° C. resulting in an emulsion.

The pH of the emulsion was adjusted to 7.5 using NaOH 1M.

The following infant formulae were prepared:
Infant formula IF1: Sunflower oleosomes SFOB1, isolated in Example 1
Infant formula IF2: Sunflower oleosomes with enlarged average globule size SFOB2, prepared in Example 2

### Example 4: Spray-Drying of Infant Formulae

Infant formulae IF1 and IF2 were spray-dried. Spray-dried infant formulae were obtained in powder form.

Infant formulae were spray-dried in a Büchi Mini Spray Dryer B-191 operated using the following parameters:
Inlet temperature: 170° C.
Aspiration: 100%
Pump: 30%
Flow control (feed rate): 600 liters/hour
Outlet temperature: 110° C.

For measuring the average globule diameter of the oleosomes in the infant formulae, the powder was re-dispersed in de-ionized water at 40° C. in an amount of 20 weight %. The average globule size of the oleosomes in the infant formulae is shown in table 2.

TABLE 2
Average globule size of oleosomes in infant formulae:

| | IF1 | IF2 |
|---|---|---|
| prior to spray-drying | 2.37 micron | 5.65 micron |
| after spray-drying | 2.39 micron | 5.14 micron |
| (measured after | | |
| re-dispersion) | | |

The spray-dried infant formulae comprising enlarged oleosomes still comprises after spray-drying enlarged oleosomes with an increased average globule size in comparison to the isolated oleosomes.

1. A nutritional composition comprising isolated and/or enlarged oleosomes and at least one nutritional ingredient other than isolated and/or enlarged oleosomes and wherein the isolated and/or enlarged oleosomes have an average globule diameter in a range of from 2.0 to 12.0 micron.

2. The nutritional composition according to claim 1, wherein the isolated and/or enlarged oleosomes are present in an amount of from 1 to 70 weight % on dry matter of the nutritional composition.

3. The nutritional composition according to claim 1, wherein the isolated and/or enlarged oleosomes have a content of proteins in an amount of from 0.2 to 6.0 weight % expressed on dry weight of oleosomes.

4. The nutritional composition according to claim 1, wherein the isolated and/or enlarged oleosomes are from a vegetable source selected from the group consisting of rapeseed, soybean, sunflower, mid and high oleic sunflower, cottonseed, coconut, brown linseed, yellow linseed, hazelnut, maize, sesame, almond, cashew, olive, avocado and shea.

5. The nutritional composition according to claim 1, wherein the at least one other nutritional ingredient is selected from the group of proteins, carbohydrates, fats, essential amino acids, essential fatty acids, vitamins, or a mixture of two or more thereof.

6. The nutritional composition according to claim 1, wherein the nutritional composition is an infant formula; and the infant formula has:
a protein content in a range of from 1.8 to 2.8 g per 100 kcal,
carbohydrate content in a range of from 9.0 to 14.0 g per 100 kcal,
lipid content in a range of from 4.4 to 6.0 g per 100 kcal
wherein at least 40% or more, at least 50% or more, at least 60% or more, at least 70% or more, at least 80% or more, at least 90% or more of the lipid content is present as isolated and/or enlarged oleosomes.

7-8. (canceled)

9. A process for preparing the nutritional composition according to claim 1, and the process is comprising the blending of the isolated and/or enlarged oleosomes with the at least one other nutritional ingredient other than isolated and/or enlarged oleosomes, and characterized in that the isolated and/or enlarged oleosomes are in powder or liquid form.

10. The nutritional composition according to claim 1, wherein the nutritional composition is an infant formula; and the infant formula has:
a protein content in a range of from 2.1 to 4.1 g 100 kcal,
a carbohydrate content in a range of from 10.0 to 12.0 g per 100 kcal,
a lipid content in a range of from 4.4 to 6.0 g per 100 kcal,
wherein at least 40% or more, at least 50% or more, at least 60% or more, at least 70% or more, at least 80% or more, at least 90% or more of the lipid content is present as isolated and/or enlarged oleosomes.
